(19) United States
(12) Patent Application Publication
(10) Pub. No.: US 2025/0200728 A1
(43) Pub. Date: Jun. 19, 2025

(54) MACHINE LEARNING-BASED MULTI-FRAME DEBLURRING

(71) Applicant: Samsung Electronics Co., Ltd., Suwon-si (KR)

(72) Inventors: Yash Sanghvi, West Lafayette, IN (US); Abhiram Gnanasambandam, Frisco, TX (US); John Seokjun Lee, Allen, TX (US); Hamid R. Sheikh, Allen, TX (US)

(21) Appl. No.: 18/539,721

(22) Filed: Dec. 14, 2023

(51) Int. Cl. G06T 5/73; G06T 3/4015; G06T 5/20; G06T 5/50; G06T 5/60; G06T 7/33

(52) U.S. Cl. CPC G06T 5/73; G06T 3/4015; G06T 5/20; G06T 5/50; G06T 5/60; G06T 7/337; G06T 2207/20056; G06T 2207/20081; G06T 2207/20084; G06T 2207/20201

(57) ABSTRACT

A method includes obtaining, using at least one processing device of an electronic device, multiple input image frames generated during a multi-frame capture operation, where each input image frame exhibits an amount of blur. The method also includes determining, using the at least one processing device, a blurriness score for each of the input image frames. The method further includes generating, using the at least one processing device, sharp denoised frames using the input image frames. In addition, the method includes generating, using the at least one processing device, a final sharp image based on the sharp denoised frames and the blurriness scores of the input image frames.

### TECHNICAL FIELD

This disclosure relates generally to image processing systems and processes. More specifically, this disclosure relates to machine learning-based multi-frame deblurring.

### BACKGROUND

Recently, artificial intelligence (AI) technology has been applied to many imaging applications in order to extend the capabilities of non-AI-based image pipelines. For example, AI technology has been applied to applications like super-resolution image generation, denoising, motion deblurring, high dynamic range (HDR) image generation, image segmentation, disparity estimation, and the like.

### SUMMARY

This disclosure provides for machine learning-based multi-frame deblurring.

In a first embodiment, a method includes obtaining, using at least one processing device of an electronic device, multiple input image frames generated during a multi-frame capture operation, where each input image frame exhibits an amount of blur. The method also includes determining, using the at least one processing device, a blurriness score for each of the input image frames. The method further includes generating, using the at least one processing device, sharp denoised frames using the input image frames. In addition, the method includes generating, using the at least one processing device, a final sharp image based on the sharp denoised frames and the blurriness scores of the input image frames.

In a second embodiment, an electronic device includes at least one processing device configured to obtain multiple input image frames generated during a multi-frame capture operation, where each input image frame exhibits an amount of blur. The at least one processing device is also configured to determine a blurriness score for each of the input image frames. The at least one processing device is further configured to generate sharp denoised frames using the input image frames. In addition, the at least one processing device is configured to generate a final sharp image based on the sharp denoised frames and the blurriness scores of the input image frames.

In a third embodiment, a non-transitory machine-readable medium contains instructions that when executed cause at least one processor of an electronic device to obtain multiple input image frames generated during a multi-frame capture operation, where each input image frame exhibits an amount of blur. The non-transitory machine-readable medium also contains instructions that when executed cause the at least one processor to determine a blurriness score for each of the input image frames. The non-transitory machine-readable medium further contains instructions that when executed cause the at least one processor to generate sharp denoised frames using the input image frames. In addition, the non-transitory machine-readable medium contains instructions that when executed cause the at least one processor to generate a final sharp image based on the sharp denoised frames and the blurriness scores of the input image frames.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example multi-frame processing pipeline in which machine learning-based multi-frame deblurring can be performed according to this disclosure;

FIGS. 3 and 4 illustrate example details of a multi-frame deblurring operation in the multi-frame processing pipeline of FIG. 2 according to this disclosure;

FIG. 5 illustrates an example process for training a single-frame preprocessing network according to this disclosure;

FIG. 6 illustrates example details of a multi-frame processing operation in the multi-frame deblurring operation of FIGS. 3 and 4 according to this disclosure;

FIG. 7 illustrates an example process for training a multi-frame processing network according to this disclosure;

FIGS. 8A and 8B illustrate examples of benefits that can be realized using one or more embodiments of this disclosure; and

FIG. 9 illustrates an example method for machine learning-based multi-frame deblurring according to this disclosure.

### DETAILED DESCRIPTION

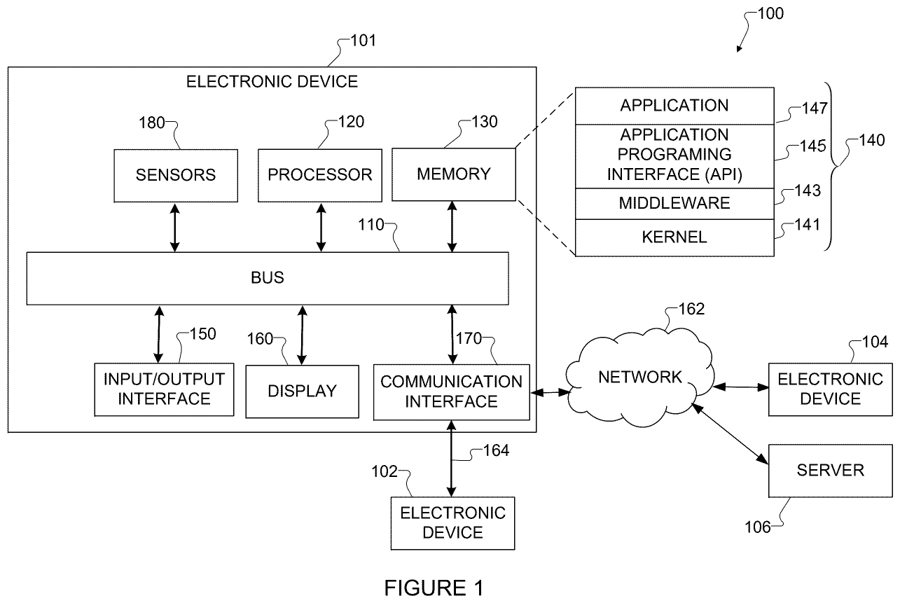

FIGS. 1 through 9, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, artificial intelligence (AI) technology has been applied to many imaging applications in order to extend the capabilities of non-AI-based image pipelines. For example, AI technology has been applied to applications like super-resolution image generation, denoising, motion deblurring, high dynamic range (HDR) image generation, image segmentation, disparity estimation, and the like.

Image deblurring is a computational technique used to generate a single sharp image from multiple blurry images. Image deblurring is often considered to be a useful or desirable imaging technique for smartphones and other portable electronic devices. This is because many images captured using portable electronic devices are hand-held and often introduce blur to captured images. This problem is even more prevalent in low light conditions when longer exposure times are used to capture images. Conventional deblurring techniques are single-frame techniques, so multiple frames captured in a single burst may be blended together into a single frame before sharpening or deblurring occurs. While this may be acceptable for some applications, single-frame techniques provide less-than-optimal results when portable or other electronic devices perform multi-frame image captures. In a typical multi-frame processing (MFP) pipeline, if the input frames are too blurry, the pipeline produces a blurry output image, and a simple sharpening in the pipeline is not enough to deblur the frames.

This disclosure provides various techniques for machine learning-based multi-frame deblurring. As described in more detail below, multiple input image frames generated during a multi-frame capture operation are obtained. Each of the input image frames can exhibit some amount of blur. A blurriness score is determined for each of the input image frames, and sharp denoised frames are generated using the input image frames. A final sharp image is generated based on the sharp denoised frames and the blurriness scores of the input image frames. In some cases, the sharp denoised frames can be generated using a first neural network, where the first neural network is trained using (i) multiple training images that exhibit blur and (ii) one or more first loss functions. Also, in some cases, the final sharp image can be generated by selecting the input image frame that exhibits a least amount of blur as a base frame and generating the final sharp image using a second neural network. The second neural network may represent a residual network having an encoder-decoder architecture. The second neural network can be trained using (i) training frames processed by the first neural network and (ii) one or more second loss functions.

In this way, the described techniques provide a multi-frame machine learning-based framework for image deblurring that blends a burst of blurry images into a single clean and sharp image. The machine learning-based framework can use information from all captured frames to perform the deblurring. As a result, the final sharp image can be of higher quality compared to conventional deblurring techniques.

Note that while some of the embodiments discussed below are described in the context of use in consumer electronic devices (such as smartphones), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for machine learning-based multi-frame deblurring.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for machine learning-based multi-frame deblurring as discussed below. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for machine learning-based multi-frame deblurring.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

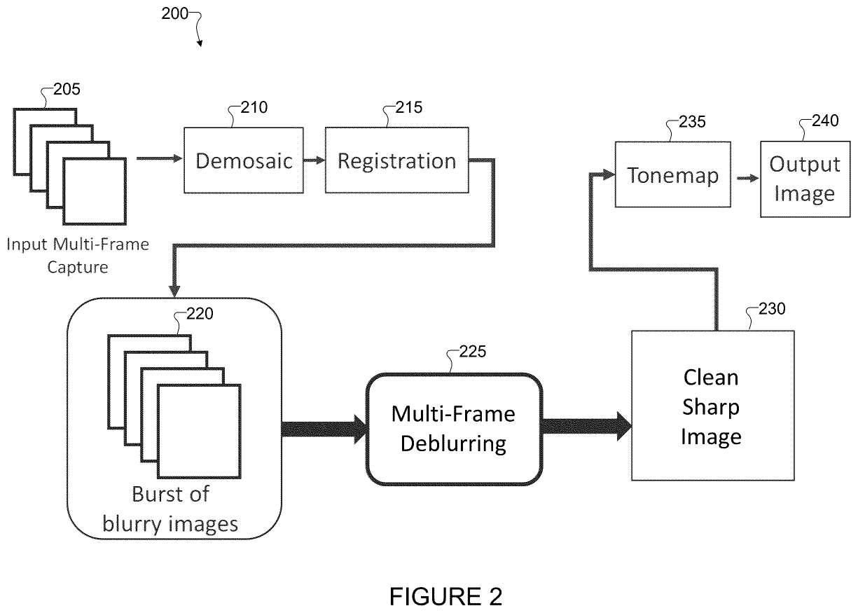

FIG. 2 illustrates an example multi-frame processing pipeline 200 in which machine learning-based multi-frame deblurring can be performed according to this disclosure. For ease of explanation, the pipeline 200 is described as being implemented using one or more components of the network configuration 100 of FIG. 1 described above, such as the electronic device 101. However, this is merely one example, and the pipeline 200 could be implemented using any other suitable device(s) (such as the server 106) and in any other suitable system(s).

As shown in FIG. 2, the pipeline 200 obtains multiple image frames 205 of a scene. For example, the electronic device 101 can obtain the image frames 205 during a multi-frame burst capture operation, meaning the image frames 205 can be obtained in rapid succession or at or near the same time. The capture operation may be performed in response to an event, such as a user actuating a shutter control or image capture control. In some embodiments, the image frames 205 are captured using a common imaging sensor 180 of the electronic device 101, such as a camera having an RGB sensor. In other embodiments, the image frames 205 are captured using multiple imaging sensors 180 of the electronic device 101. Also, in some embodiments, the image frames 205 can be multi-frame one-channel (mosaic) raw RGB images. However, this is merely one example, and image frames having other numbers of channels or image data in other domains are within the scope of this disclosure.

The electronic device 101 performs a demosaic operation 210 on the image frames 205 to convert the mosaic image frames 205 into multi-channel frames (such as four-channel frames). The demosaic operation 210 generally operates here to convert image data produced using a Bayer filter array or other color filter array into reconstructed red-green-blue (RGB) data or other image data in order to generate a demosaiced image. For example, the demosaic operation 210 can perform various interpolations to fill in missing information, such as by estimating other colors' image data for each pixel. When using a Bayer filter array or some other types of color filter arrays, approximately twice as many pixels may capture image data using green filters compared to pixels that capture image data using red or blue filters. This can introduce non-uniformities into the captured image data, such as when the red and blue image data each have a lower SNR and a lower sampling rate compared to the green image data. Among other things, the green image data can capture high-frequency image content more effectively than the red and blue image data. The demosaic operation 210 can take information captured by at least one highly-sampled channel (such as the green channel and/or the white channel) and use that information to correct limitations of lower-sampled channels (such as the red and blue channels), which can help to reintroduce high-frequency image content into the red and blue image data. Note, however, that this disclosure is not limited to any particular technique(s) for demosaicing images, and the demosaic operation 210 can use any suitable technique(s) for demosaicing images.

The electronic device 101 also performs a registration operation 215 on the demosaiced image frames in order to align the demosaiced image frames. For example, the demosaiced image frames may undergo alignment so that common features in different demosaiced image frames are at the same or substantially the same locations in the aligned versions of the demosaiced image frames. In some embodiments, the registration operation 215 may select a reference image frame and modify one or more non-reference image frames so as to be aligned with the reference image frame. In some cases, for instance, the registration operation 215 generates a warp or alignment map for each non-reference image frame, where each warp or alignment map includes or is based on one or more motion vectors that identify how the position(s) of one or more specific features in the associated non-reference image frame should be altered in order to be in the position(s) of the same feature(s) in the reference image frame. Alignment may be needed in order to compensate for misalignment caused by the electronic device 101 moving or rotating in between image captures, which causes objects in the image frames 205 to move or rotate slightly (as is common with handheld devices). The registration operation 215 may use any suitable technique(s) for image registration. In some embodiments, the demosaiced image frames can be aligned both geometrically and photometrically. In some cases, the registration operation 215 can be performed by finding an optimal homography that preserves image content and matches the most-related interesting feature points of the demosaiced image frames. In particular embodiments, the registration operation 215 can use global Oriented FAST and Rotated BRIEF (ORB) features and local features from a block search to identify how to align the image frames. Note, however, that this disclosure is not limited to any particular technique(s) for aligning image frames, and the registration operation 215 can use any suitable technique(s) for aligning image frames.

The demosaic operation 210 and the registration operation 215 here operate to generate a burst of blurry image frames 220. The blurry image frames 220 exhibit an amount of blur because the image frames 205 themselves may exhibit some blur and/or because the demosaic operation 210 and the registration operation 215 are not perfectly accurate. To address the blurriness, the electronic device 101 performs a multi-frame deblurring operation 225 using the blurry image frames 220 as an input. The multi-frame deblurring operation 225 generates a clean sharp image 230 that exhibits less (ideally little or no) blur. As described in greater detail below, the multi-frame deblurring operation 225 supports multiple machine learning-based operations, which in some embodiments can involve one or more neural networks or other deep learning networks.

The electronic device 101 can perform a tone mapping operation 235, which adjusts colors in the clean sharp image 230 in order to generate an output image 240. This can be useful or important in various applications, such as when generating HDR images. For instance, since generating an HDR image often involves capturing multiple images of a scene using different exposures and combining the captured images to produce the HDR image, this type of processing can often result in the creation of unnatural tone within the HDR image. The tone mapping operation 235 can therefore use one or more color mappings to adjust the colors contained in the sharpened image. The output image 240 that is generated may represent a final image of the scene. Note, however, that the output image 240 may undergo one or more additional post-processing operations (if desired) to produce a final image of the scene. The tone mapping operation 235 may use any suitable technique(s) to perform tone mapping, such as one or more global tone mapping techniques and/or one or more local tone mapping techniques. As a particular example, the tone mapping operation 235 may multiply each pixel of the sharpened image by a corresponding gain value to help ensure that the resulting output image 240 can be displayed appropriately.

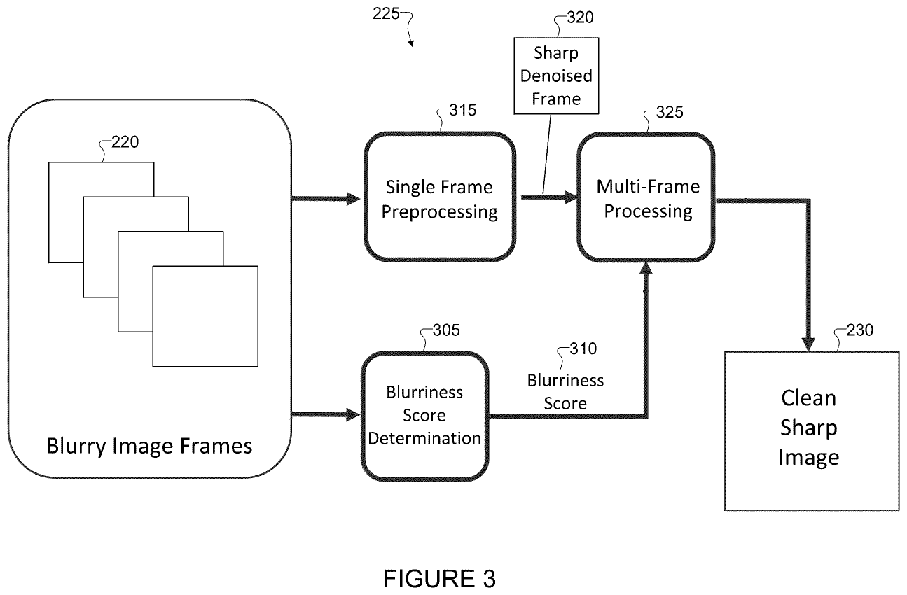

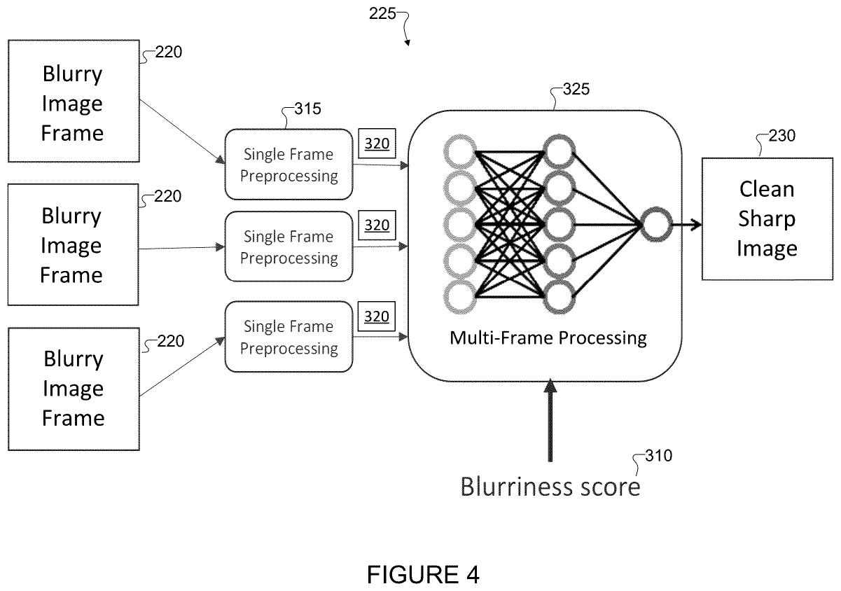

FIGS. 3 and 4 illustrate example details of a multi-frame deblurring operation 225 in the multi-frame processing pipeline 200 of FIG. 2 according to this disclosure. As shown in FIGS. 3 and 4, the multi-frame deblurring operation 225 receives the blurry image frames 220 as inputs and generates the clean sharp image 230 as an output. During the multi-frame deblurring operation 225, the electronic device 101 performs a blurriness score determination operation 305 in which the electronic device 101 determines a blurriness score 310 for each of the blurry image frames 220. In some cases, some of the blurry image frames 220 can have milder or greater blur than others of the blurry image frames 220. That is, the amount of blur can be different in different ones of the blurry image frames 220. Here, the electronic device 101 can perform the blurriness score determination operation 305 in order to determine the amount of blur present in each blurry image frame 220.

To quantify the identified blurriness, the electronic device 101 assigns a blurriness score 310 to each blurry image frame 220. The blurriness scores 310 can be determined in any suitable manner. For example, in some embodiments, the electronic device 101 converts each blurry image frame 220 to a spatial frequency domain, such as by using a Fourier transform. The electronic device 101 determines the relative Fourier weights of each blurry image frame 220, such as by using the following.

$${w}_{i} ( {ξ}_{j} ) = \frac{{\vert {y}_{j} ( {ξ}_{j} ) \vert}^{p}}{{\sum }_{m} {\vert {y}_{m} ( {ξ}_{j} ) \vert}^{p}}$$

Here, wᵢ(ξⱼ) represents the Fourier weights for image frame yᵢ at frequency ξⱼ. After determining the relative Fourier weights for a blurry image frame 220, the electronic device 101 determines an average of the relative Fourier weights over the spatial frequency domain for that blurry image frame 220 and assigns the result as the blurriness score 310 for that blurry image frame 220, such as by using the following.

$${y}_{i} = {\sum }_{j} \vert {w}_{i} ( {ξ}_{j} ) \vert$$

Here, yᵢ represents the blurriness score 310 for the blurry image frame 220.

Using these equations, it can be seen that higher blurriness scores 310 are associated with smaller amounts of blur. This is based on the intuition that motion blur attenuates higher frequency components of an image. Of course, this is only one example for determining a blurriness score 310, and any other suitable techniques for determining a blurriness score 310 may be used. In other embodiments, for example, higher blurriness scores 310 may be associated with larger amounts of blur. As described below, the blurriness score 310 for each blurry image frame 220 can be used in the multi-frame deblurring operation 225 to improve deblurring results.

In addition to the blurriness score determination operation 305, the multi-frame deblurring operation 225 also includes a single-frame preprocessing operation 315 and a multi-frame processing operation 325. As shown in FIG. 4, the electronic device 101 performs the single-frame preprocessing operation 315 separately on each blurry image frame 220 in order to generate a sharp denoised frame 320 from each blurry image frame 220. The electronic device 101 also performs the multi-frame processing operation 325 in order to combine the sharp denoised frames 320 into a single clean sharp image 230.

Each operation 315 and 325 is a machine learning-based operation, which can include one or more neural networks, other deep learning networks, or other machine learning models, as described below. For instance, the single-frame preprocessing operation 315 may employ at least one machine learning-based single-frame preprocessing network, such as a deep learning network, that is trained to generate a sharp denoised frame 320 using a blurry image frame 220 as an input. The multi-frame processing operation 325 may employ at least one machine learning-based multi-frame processing network, such as a deep learning network, that is trained to generate a clean sharp image 230 using sharp denoised frames 320 as inputs.

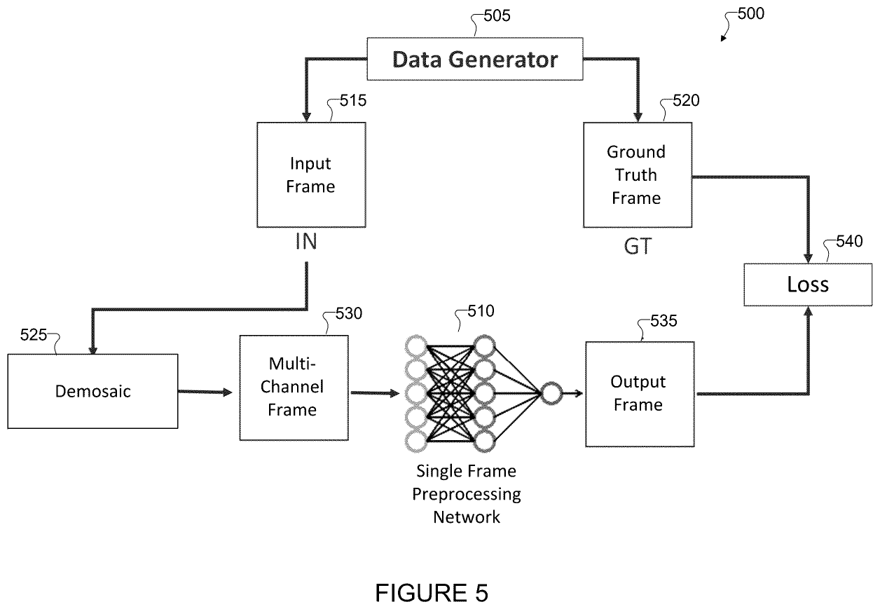

FIG. 5 illustrates an example process 500 for training a single-frame preprocessing network according to this disclosure. As shown in FIG. 5, a data generator 505 generates training data for training the single-frame preprocessing network 510. The training data includes one or more input frames 515 and one or more corresponding ground truth frames 520. In some cases, the input frames 515 and ground truth frames 520 could represent real RGB image data captured using a camera or other imaging sensor(s). Also or alternatively, the input frames 515 and ground truth frames 520 could represent synthetic image data that is generated to include an amount of blur. The process 500 includes a demosaic operation 525 that is performed on the input frames 515. The demosaic operation 525 converts the input frames 515 into multi-channel frames 530 (such as four-channel frames). In some embodiments, the demosaic operation 525 is the same as or similar to the demosaic operation 210 of FIG. 2.

The multi-channel frames 530 are provided as input to the single-frame preprocessing network 510, which can use any suitable machine learning-based architecture. In some cases, the single-frame preprocessing network 510 can represent an encoder-decoder-based deep learning network. The single-frame preprocessing network 510 generates an output frame 535, which is a sharp denoised frame, using the input frames 515. The output frame 535 is compared to the ground truth frame 520 in order to determine a loss 540 using one or more loss functions. Any suitable loss function(s) can be used in the training process 500, such as an L1 loss function. If the calculated loss for a single generated output frame 535 or a collection of generated output frames 535 exceeds a specified threshold, weights or other parameters of the single-frame preprocessing network 510 can be modified, and another training iteration can occur in which the same or different input frames 515 are provided to the single-frame preprocessing network 510 and the resulting output frame or frames 535 are compared to the associated ground truth frame(s) 520 in order to generate an updated loss 540. Ideally, over time, the single-frame preprocessing network 510 becomes more accurate in generating the output frames 535, and the loss 540 decreases to a suitably-low value. Once trained, the single-frame preprocessing network 510 is configured to generate sharp denoised frames 320.

Turning again to FIGS. 3 and 4, the sharp denoised frames 320 and the blurriness scores 310 generated from the blurry image frames 220 are provided as input to the multi-frame processing operation 325. The electronic device 101 performs the multi-frame processing operation 325 in order to combine the sharp denoised frames 320 into the clean sharp image 230.

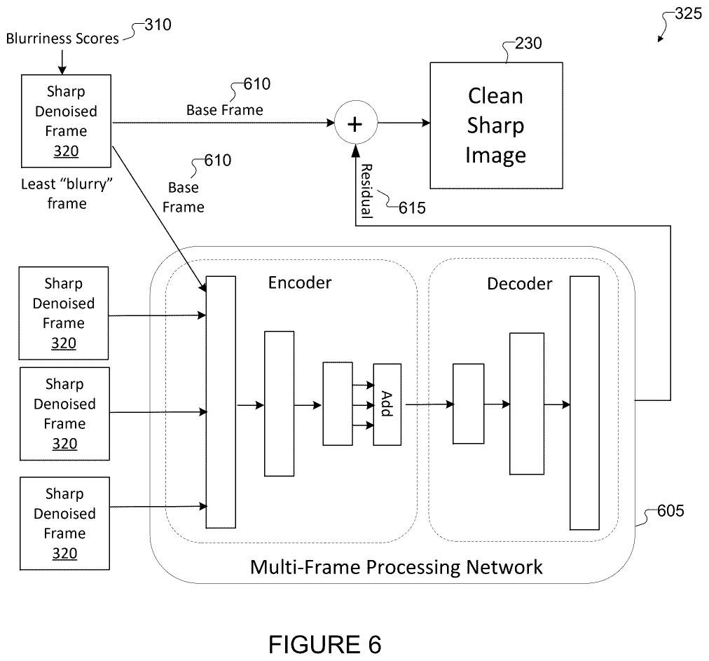

FIG. 6 illustrates example details of a multi-frame processing operation 325 in the multi-frame deblurring operation 225 of FIGS. 3 and 4 according to this disclosure. As shown in FIG. 6, the multi-frame processing operation 325 employs a machine learning-based multi-frame processing network 605, such as a neural network, other deep learning network, or other machine learning model, that is trained to generate a clean sharp image 230 using multiple sharp denoised frames 320 as inputs. In FIG. 6, the multi-frame processing network 605 is an encoder-decoder-based deep learning residual network, although this is merely one example. Other embodiments could include any other suitable machine learning model.

In FIG. 6, the sharp denoised frames 320 are provided as inputs to the multi-frame processing network 605. The electronic device 101 also uses the blurriness scores 310 associated with each blurry image frame 220 to select the least-blurry blurry image frame 220. For example, the electronic device 101 may select the blurry image frame 220 having the highest blurriness score 310 (which can be indicative of the lowest amount of blur), although other embodiments may select the blurry image frame 220 having the lowest blurriness score 310. The electronic device 101 selects the sharp denoised frame 320 generated from the least-blurry blurry image frame 220 as a base frame 610, and the base frame 610 is provided as an input to the multi-frame processing network 605. The multi-frame processing network 605 receives the sharp denoised frames 320 as inputs and determines a residual 615, which is added to the base frame 610 in order to generate the clean sharp image 230.

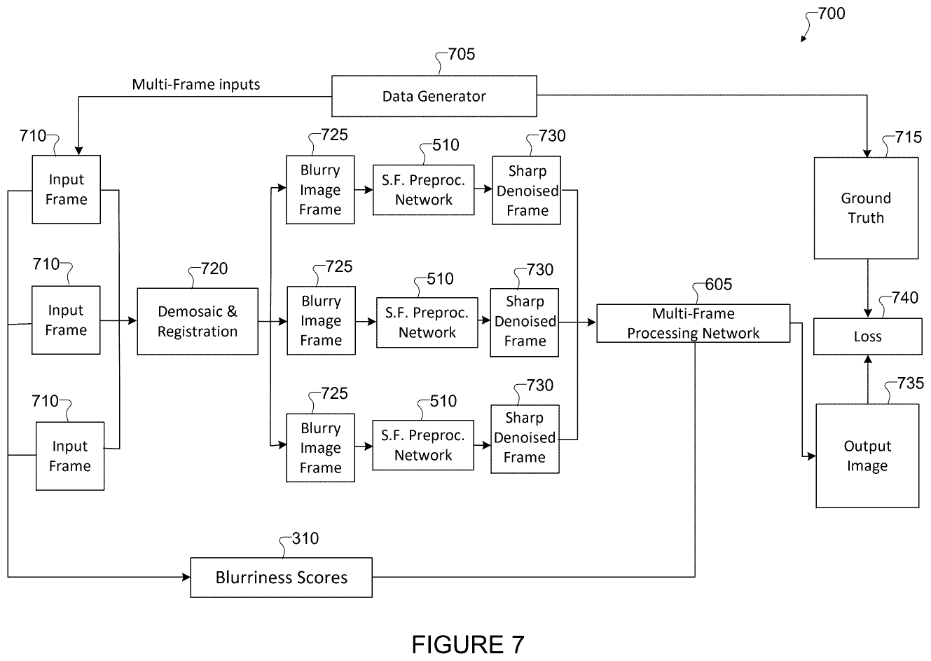

As discussed above, the multi-frame processing network 605 can be trained to use sharp denoised frames 320 to predict the residual 615. FIG. 7 illustrates an example process 700 for training the multi-frame processing network 605 according to this disclosure. As shown in FIG. 7, a data generator 705 generates training data for training the multi-frame processing network 605. The training data includes multiple input frames 710 and corresponding ground truth frames 715. In some cases, the input frames 710 and ground truth frames 715 could represent real RGB Bayer image data captured using a camera or other imaging sensor(s). Also or alternatively, the input frames 710 and ground truth frames 715 could represent synthetic image data that is generated to include an amount of blur.

The input frames 710 are processed using portions of a multi-frame processing pipeline (such as the pipeline 200), where the input frames 710 go through demosaic and registration operations 720 to generate blurry image frames 725. Here, the demosaic and registration operations 720 can be the same as or similar to the demosaic operation 210 and the registration operation 215 of FIG. 2. Likewise, the blurry image frames 725 can be similar to the blurry image frames 220. In some embodiments, each of the blurry image frames 725 is also or alternatively blurred using a random jitter.

Each blurry image frame 725 is preprocessed using the single-frame preprocessing network 510, which outputs a sharp denoised frame 730. The sharp denoised frames 730 are provided as a multi-frame input to train the multi-frame processing network 605. The multi-frame processing network 605 generates an output image 735, which ideally is a clean sharp image (or at least a cleaner sharper image relative to the blurry image frames 725). The output image 735 is compared to the ground truth frame 715 in order to determine a loss 740 using one or more loss functions. Any suitable loss function(s) can be used in the training process 700, such as an L1 loss function. If the calculated loss for a single generated output image 735 or a collection of generated output images 735 exceeds a specified threshold, weights or other parameters of the multi-frame processing network 605 can be modified, and another training iteration can occur in which the same or different inputs are provided to the multi-frame processing network 605 and the resulting output image or images 735 are compared to the associated ground truth frame(s) 715 in order to generate an updated loss 740. Ideally, over time, the multi-frame processing network 605 becomes more accurate in generating the output images 735, and the loss 740 decreases to a suitably-low value. Once trained, the multi-frame processing network 605 is configured to generate clean sharp images 230.

Although FIGS. 2 through 7 illustrate one example of a pipeline 200 that includes machine learning-based multi-frame deblurring and related details, various changes may be made to FIGS. 2 through 7. For example, while the pipeline 200 and the training processes 500 and 700 are described as involving specific sequences of operations, various operations described with respect to FIGS. 2 through 7 could overlap, occur in parallel, occur in a different order, or occur any number of times (including zero times). Also, the specific operations shown in FIGS. 2 through 7 are examples only, and other techniques could be used to perform each of the operations shown in FIGS. 2 through 7.

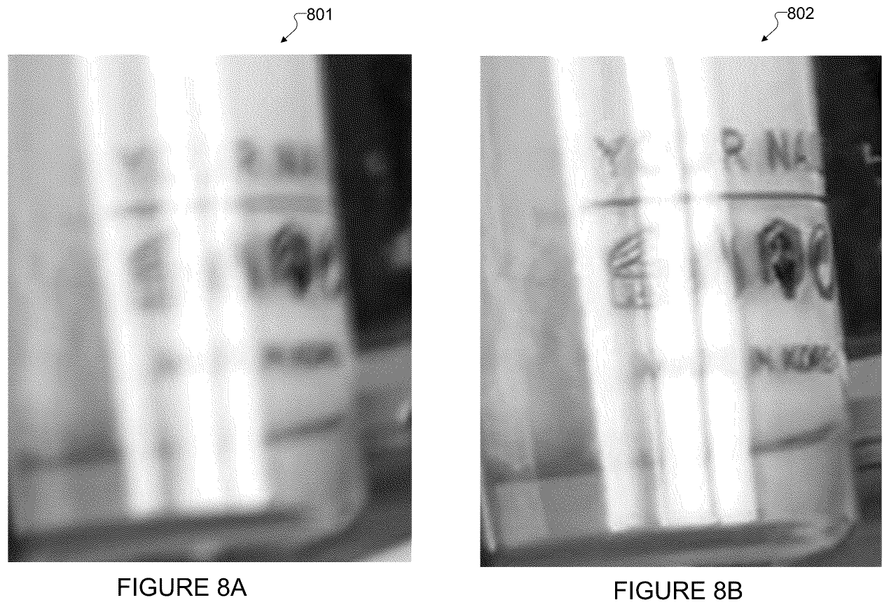

FIGS. 8A and 8B illustrate examples of benefits that can be realized using one or more embodiments of this disclosure. In FIG. 8A, an image 801 of a scene is shown that has been generated or captured using a camera or other imaging sensor. As shown in FIG. 8A, the image 801 includes significant blurring in the foreground.

In FIG. 8B, an image 802 of the same scene has been deblurred using machine learning-based multi-frame deblurring as disclosed above (such as is described in FIGS. 2 through 7). As evident by FIG. 8B, the image 802 exhibits superior image quality with significantly less blur compared to the image 801. In particular, the image 802 is much sharper and more realistic than the image 801, especially in the foreground regions.

Although FIGS. 8A and 8B illustrate one example of benefits that can be realized using one or more embodiments of this disclosure, various changes may be made to FIGS. 8A and 8B. For example, images can be captured of numerous scenes under different lighting conditions and from different distances and angles, and these figures do not limit the scope of this disclosure. These figures are merely meant to illustrate one example of the types of benefits that might be obtainable using the techniques described above.

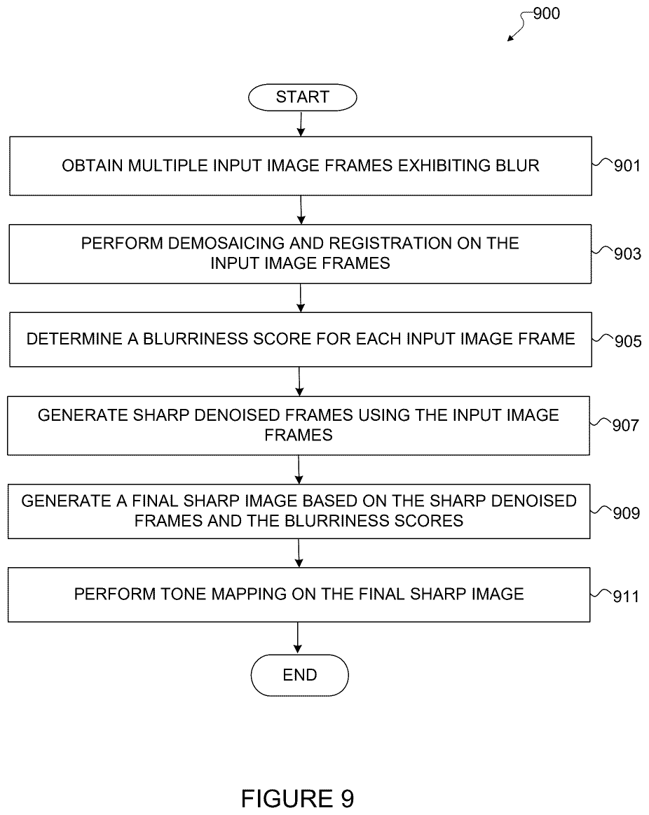

FIG. 9 illustrates an example method 900 for machine learning-based multi-frame deblurring according to this disclosure. For ease of explanation, the method 900 shown in FIG. 9 is described as being performed using the electronic device 101 shown in FIG. 1 and the pipeline 200 shown in FIG. 2. However, the method 900 shown in FIG. 9 could be performed using any other suitable device(s) and pipeline(s) and in any other suitable system(s).

As shown in FIG. 9, at step 901, multiple input image frames generated during a multi-frame capture operation are obtained, where each input image frame exhibits an amount of blur. This could include, for example, the processor 120 of the electronic device 101 obtaining multiple image frames 205. At step 903, demosaicing and registration operations are performed on the input image frames. This could include, for example, the processor 120 of the electronic device 101 performing the demosaic operation 210 and the registration operation 215 on the image frames 205.

At step 905, a blurriness score is determined for each of the input image frames. This could include, for example, the processor 120 of the electronic device 101 determining a blurriness score 310 for each of the blurry image frames 220, such as in the blurriness score determination operation 305. At step 907, sharp denoised frames are generated using the input image frames. This could include, for example, the processor 120 of the electronic device 101 using the single-frame preprocessing network 510 to generate sharp denoised frames 320, such as in the single-frame preprocessing operation 315.

At step 909, a final sharp image is generated based on the sharp denoised frames and the blurriness scores of the input image frames. This could include, for example, the processor 120 of the electronic device 101 using the multi-frame processing network 605 to generate the clean sharp image 230, such as in the multi-frame deblurring operation 225. At step 911, tone mapping is performed on the final sharp image to generate an output image. This could include, for example, the processor 120 of the electronic device 101 performing the tone mapping operation 235 on the clean sharp image 230 to generate the output image 240.

Although FIG. 9 illustrates one example of a method 900 for machine learning-based multi-frame deblurring, various changes may be made to FIG. 9. For example, while shown as a series of steps, various steps in FIG. 9 could overlap, occur in parallel, occur in a different order, or occur any number of times (including zero times).

Note that the operations and functions shown in or described with respect to FIGS. 2 through 9 can be implemented in an electronic device 101, 102, 104, server 106, or other device(s) in any suitable manner. For example, in some embodiments, the operations and functions shown in or described with respect to FIGS. 2 through 9 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 9 can be implemented or supported using dedicated hardware components. In general, the operations and functions shown in or described with respect to FIGS. 2 through 9 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple input image frames generated during a multi-frame capture operation, each input image frame exhibiting an amount of blur;
determining, using the at least one processing device, a blurriness score for each of the input image frames;
generating, using the at least one processing device, sharp denoised frames using the input image frames; and
generating, using the at least one processing device, a final sharp image based on the sharp denoised frames and the blurriness scores of the input image frames.

2. The method of claim 1, wherein determining the blurriness score for each of the input image frames comprises:
determining an average of Fourier weights of the input image frame in a spatial frequency domain; and
assigning the blurriness score to the input image frame based on the determined average.

3. The method of claim 1, wherein generating the sharp denoised frames comprises:
generating the sharp denoised frames using a first neural network that receives the input image frames as input, the first neural network trained using (i) multiple training images that exhibit blur and (ii) one or more first loss functions.

4. The method of claim 3, wherein generating the final sharp image comprises:
selecting, as a base frame, the input image frame that exhibits a least amount of blur based on the blurriness scores; and
generating the final sharp image using a second neural network that receives the sharp denoised frames as input and determines a residual to add to the base frame, the second neural network comprising a residual network having an encoder-decoder architecture.

5. The method of claim 4, wherein the second neural network is trained using (i) training frames processed by the first neural network and (ii) one or more second loss functions.

6. The method of claim 5, wherein each of the training frames is blurred using a random jitter before being processed by the first neural network.

7. The method of claim 1, further comprising:
performing demosaicing and registration operations on the input image frames before the blurriness score for each of the input image frames is determined.

8. An electronic device comprising:
at least one processing device configured to:
obtain multiple input image frames generated during a multi-frame capture operation, each input image frame exhibiting an amount of blur;
determine a blurriness score for each of the input image frames;
generate sharp denoised frames using the input image frames; and
generate a final sharp image based on the sharp denoised frames and the blurriness scores of the input image frames.

9. The electronic device of claim 8, wherein, to determine the blurriness score for each of the input image frames, the at least one processing device is configured to:
determine an average of Fourier weights of the input image frame in a spatial frequency domain; and
assign the blurriness score to the input image frame based on the determined average.

10. The electronic device of claim 8, wherein, to generate the sharp denoised frames, the at least one processing device is configured to generate the sharp denoised frames using a first neural network that receives the input image frames as input, the first neural network trained using (i) multiple training images that exhibit blur and (ii) one or more first loss functions.

11. The electronic device of claim 10, wherein, to generate the final sharp image, the at least one processing device is configured to:
select, as a base frame, the input image frame that exhibits a least amount of blur based on the blurriness scores; and
generate the final sharp image using a second neural network that receives the sharp denoised frames as input and determines a residual to add to the base frame, the second neural network comprising a residual network having an encoder-decoder architecture.

12. The electronic device of claim 11, wherein the second neural network is trained using (i) training frames processed by the first neural network and (ii) one or more second loss functions.

13. The electronic device of claim 12, wherein each of the training frames is blurred using a random jitter before being processed by the first neural network.

14. The electronic device of claim 8, wherein the at least one processing device is further configured to perform demosaicing and registration operations on the input image frames before determining the blurriness score for each of the input image frames.

15. A non-transitory machine-readable medium containing instructions that when executed cause at least one processor of an electronic device to:
obtain multiple input image frames generated during a multi-frame capture operation, each input image frame exhibiting an amount of blur;
determine a blurriness score for each of the input image frames;
generate sharp denoised frames using the input image frames; and
generate a final sharp image based on the sharp denoised frames and the blurriness scores of the input image frames.

16. The non-transitory machine-readable medium of claim 15, wherein the instructions that when executed cause the at least one processor to determine the blurriness score for each of the input image frames comprise:
instructions that when executed cause the at least one processor to:
determine an average of Fourier weights of the input image frame in a spatial frequency domain; and
assign the blurriness score to the input image frame based on the determined average.

17. The non-transitory machine-readable medium of claim 15, wherein the instructions that when executed cause the at least one processor to generate the sharp denoised frames comprise:
instructions that when executed cause the at least one processor to generate the sharp denoised frames using a first neural network that receives the input image frames as input, the first neural network trained using (i) multiple training images that exhibit blur and (ii) one or more first loss functions.

18. The non-transitory machine-readable medium of claim 17, wherein the instructions that when executed cause the at least one processor to generate the final sharp image comprise:
instructions that when executed cause the at least one processor to:
select, as a base frame, the input image frame that exhibits a least amount of blur based on the blurriness scores; and
generate the final sharp image using a second neural network that receives the sharp denoised frames as input and determines a residual to add to the base frame, the second neural network comprising a residual network having an encoder-decoder architecture.

19. The non-transitory machine-readable medium of claim 18, wherein the second neural network is trained using (i) training frames processed by the first neural network and (ii) one or more second loss functions.

20. The non-transitory machine-readable medium of claim 15, further containing instructions that when executed cause the at least one processor to perform demosaicing and registration operations on the input image frames before determining the blurriness score for each of the input image frames.
